(19) United States
(12) Patent Application Publication
(10) Pub. No.: US 2025/0174115 A1
(43) Pub. Date: May 29, 2025

(54) FIELD DEVICE AND SYSTEM COMPRISING THE FIELD DEVICE

(71) Applicant: Endress+Hauser Conducta GmbH+Co. KG, Gerlingen (DE)

(72) Inventors: Guido Mennicken, Leonberg (DE); Thomas Schipolowski, Stuttgart (DE); Nikolai-Sven Strohfeldt, Stuttgart (DE); Michael Wiederkehr, Leonberg (DE); Claudia Keller, Leonberg (DE); Bernd Flaig, Markgröningen (DE); Katinka Melichar, Würzburg (DE); Thomas Aull, Würzburg (DE)

(21) Appl. No.: 18/961,952

(22) Filed: Nov. 27, 2024

(30) Foreign Application Priority Data
Nov. 27, 2023 (DE) 10 2023 133 020.9

(51) Int. Cl. G08C 17/02; G01D 9/00; G01D 18/00

(52) U.S. Cl. CPC G08C 17/02; G01D 9/005; G01D 18/00

(57) ABSTRACT

An automation field device having a display unit with a user interface, or which makes a user interface available to a network participant via a communication connection, is provided. The field device is designed to carry out a plurality of different processes, where the field device is designed to output first information about a current first process together with second information about a second process via the user interface. The first information comprises a name and/or a description of the first process, and a first indicator of a remaining first time period until completion of the first process or first process step, and where the second information includes a name and description of the second process, and a second indicator of a second time period until the second process is carried out.

### CROSS-REFERENCE TO RELATED APPLICATION

The present application is related to and claims the priority benefit of German Patent Application No. 10 2023 133 020.9, filed on Nov. 27, 2023, the entire contents of which are incorporated herein by reference.

### TECHNICAL FIELD

The present disclosure relates to a field device. Furthermore, the present disclosure relates to a system which comprises the field device according to the present disclosure.

### BACKGROUND

Field devices that are used in industrial installations are already known from the prior art. Field devices are often used in process automation technology, as well as in manufacturing automation technology. In principle, all devices which are process-oriented and which supply or process process-relevant information are referred to as field devices. Field devices are thus used for detecting and/or influencing process variables. Measuring devices, or sensors, are used for detecting process variables. These are used, for example, for pressure and temperature measurement, conductivity measurement, flow measurement, pH measurement, fill level measurement etc., and detect the corresponding process variables of pressure, temperature, conductivity, pH value, fill level, flow etc. Actuators are used for influencing process variables. These are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the Endress+Hauser group.

In process control engineering, sensors are positioned in an environment in order to measure its physical and/or chemical properties. The sensors are, for example, pH sensors, conductivity sensors, turbidity sensors, oxygen sensors, etc. A transmitter, also known as a measuring transducer, is located in the region of the sensor, which transmitter converts and processes the sensor signal. The sensor and the transmitter form a measuring chain, which in connection with the present disclosure is understood to mean a transfer path of a primary sensor signal, which depends on a parameter to be measured, to a unit downstream of the sensor, wherein the downstream unit receives the sensor signal or a processed sensor signal in order to process it further or to react to it. This measuring chain, or the transmitter on its own, is also referred to as a field device in connection with the present disclosure.

Analyzers or samplers as special forms of transmitters are designed to ascertain values by means of digestion methods. Analyzers are used to analyze or examine samples, for example water samples. Analyzers comprise a housing in which the measuring electronics, one or more sample holders and a plurality of sensors for recording physical, chemical or biological parameters of the sample are arranged. These analyses are carried out as so-called “processes”. Such a process consists of one or more process steps. In the case of the process of analyzing a sample, the process steps can be, for example, introducing the sample, forwarding the sample, measuring it, etc. Cleaning and calibration are also processes carried out on analyzers or samplers.

Analyzers or samplers available today have a display unit that shows which process is currently being carried out or when the next process will start if nothing is currently in progress. If a process is already in progress, the user cannot see what will be processed next. This makes it difficult for the user to plan and carry out further processes, such as maintenance tasks.

Modern apparatuses may also be able to perform more complex and unscheduled tasks, for example due to measurement errors or external activation (e.g. via a fieldbus network). At the same time, the scheduled tasks also have very different intervals (e.g. a measurement is typically carried out every two hours, while calibration is typically carried out every four days), which means that even an experienced user is not always intuitively clear about which process or process step comes next, or when exactly it will be carried out.

### SUMMARY

Proceeding from this problem, the object of the present disclosure is to present a field device which allows processes to be scheduled more easily.

The object is achieved by an automation field device which has a display unit with a user interface or which is designed to make the user interface available to a network participant via a communication connection, wherein the field device is designed to carry out a plurality of different processes or process steps within such a process, the field device being designed to output information about a current first process or first process step together with information about at least one second process or second process step following the first process or first process step, via the user interface, wherein the information about the first process or first process step comprise a name and/or a description of the first process or process step, and a first indicator of a remaining first time period until completion of the first process or first process step, and wherein the information about the second process or second process step comprise a name and/or a description of the second process or process step, and a second indicator of a remaining second time period until the second process or process step is carried out.

According to the present disclosure, the user is thus provided with information about how long the current process or the current process step has left and the length of time until the next process step starts in a simple manner. The user is therefore assured of what the apparatus is currently doing and how and when they can or must intervene safely.

According to one embodiment of the field device, it is provided that the first time period and/or the second time period is/are calculated on the basis of one or more simulations. For this purpose, the field device is assigned a knowledge base and/or a trained algorithm, which contain(s) a connection between different applications, processes or process steps and their average durations.

Alternatively or additionally, it may be provided that the first time period and/or the second time period is/are calculated on the basis of historical values. For this purpose, the field device has a database for past real first and second time periods, which is accessed by an algorithm for calculating the first time period and/or the second time period. For example, the historical values contain information about the average duration of a measurement in the past week. If simulations are also used for calculation purposes, the algorithm can use a combination of the historical values and simulations. Thus, the results of the simulation can be improved. For example, the real historical values can deviate significantly from the simulated values if, for example, the sample supply line is deteriorated has sample supply line and therefore there is not always enough sample available to carry out the measurements.

Advantageously, it can be provided that the first information about the first process or first process step comprise a first symbol, and wherein the second information about the second process or second process step comprise a second symbol. The symbols, which are pictograms, for example, are selected to suit the corresponding processes or process steps and visualized on the user interface.

According to an advantageous embodiment of the field device, it is provided that the first indicator is designed as a circular arc, wherein the circular arc increases or decreases proportionally to the progression of the first process or first process step. The circular arc therefore depends directly on the remaining first time period. For example, if the first process has just started, the circular arc is almost completely present or filled. As the remaining first time period is reduced, the circular arc is reduced more and more. The opposite case can also be provided such that the circular arc is built up more and more as the first time period decreases.

It can be provided that the circular arc is arranged as a first indicator around the first symbol. This means that the user can immediately see which process or process step is currently being carried out and how far the first process or first process step has already progressed.

One embodiment of the field device provides that the second indicator is designed as a bar, the length of which is proportional to the progression of the second time period. In particular, it is provided that as the second time period decreases, i.e. as the time until the start of the second process or second process step reduces, the length of the bar decreases.

Advantageously, as the second indicator, the bar connects the first symbol to the second symbol. As the second time period decreases, the second symbol moves closer to the first symbol. The user can therefore intuitively determine the time until the next process or process step.

Advantageously, the field device is designed to switch the first process or first process step for the second process or second process step after completion such that the second process or second process step becomes the current first process or process step. It can also be provided that information is not displayed for two processes, but for three or more processes. For each of the processes, the current time period remaining until a corresponding process is carried out is then visualized accordingly.

According to an advantageous embodiment of the field device, it is provided that the field device is an analyzer having measuring electronics, sample holders and a plurality of sensors for recording physical, chemical or biological parameters of a sample. It can then be further provided that a process is one of the following: recording physical, chemical or biological parameters of the sample; cleaning sample holders and/or sensors; maintenance mode; checking a measurement deviation of the field device to check the measurement deviation (also known as “reference sample inspection”); calibrating the analyzer.

It is clear to a person skilled in the art that other processes not listed here can also be used within the scope of the present disclosure, for example a “grab sample” process (measuring a sample from a beaker), which provides manual confirmation steps by the user.

These processes then each contain at least one process step. All process steps of a process must be carried out successively in order to complete the process. In order to calibrate the analyzer, the individual process steps can be, for example, carrying out one or more measurements and adjusting the analyzer on the basis of a comparison between the measured values and reference values.

Furthermore, the object is achieved by a system comprising a field device according to the present disclosure and a network participant, wherein the field device and the network participant are connected for communication via a communication network, the field device being designed to make the user interface available to the network participant via a communication connection.

For example, the system can be designed in such a way that the user interface runs as a first web server on a Linux system that is connected to the backend via LVDS or Ethernet, whereby the user receives access to a second web server and thus to the user interface via the second network participant.

The system can, for example, also be designed in such a way that a computing unit (e.g. a PC, laptop or mobile device, in particular a smartphone or tablet) is provided as an additional network participant. The field device transmits the information relating to the user interface wirelessly (in particular via Bluetooth, Bluetooth LE or Wi-Fi) to the additional network participant, which then makes the user interface available to the user via a display unit.

The system can also be designed, for example, in such a way that a cloud-based platform is provided as a network participant on which one or more applications are executed. Such an application can be a digital twin of the field device. The field device transmits the data relating to the user interface to its digital twin on the cloud-based platform via the communication connection, in particular the Internet. The user can now access the digital twin with their computing unit (e.g. PC or mobile device) and display the current user interface.

The network participant is, for example, a PC or a laptop, but can also be designed as another field device.

### BRIEF DESCRIPTION OF THE DRAWINGS

The present disclosure is explained in greater detail with reference to the following figures. In the figures:

FIG. 1 shows an embodiment of the system according to the present disclosure;

FIG. 2 shows a representation of the principle of the user interface when the first process or first process step is running;

FIG. 3 shows a representation of the principle of the user interface when the first process or first process step is not active;

FIG. 4 shows a representation of the user interface of a first example application of the field device; and

FIG. 5 shows a representation of the user interface of a second example application of the field device.

### DETAILED DESCRIPTION

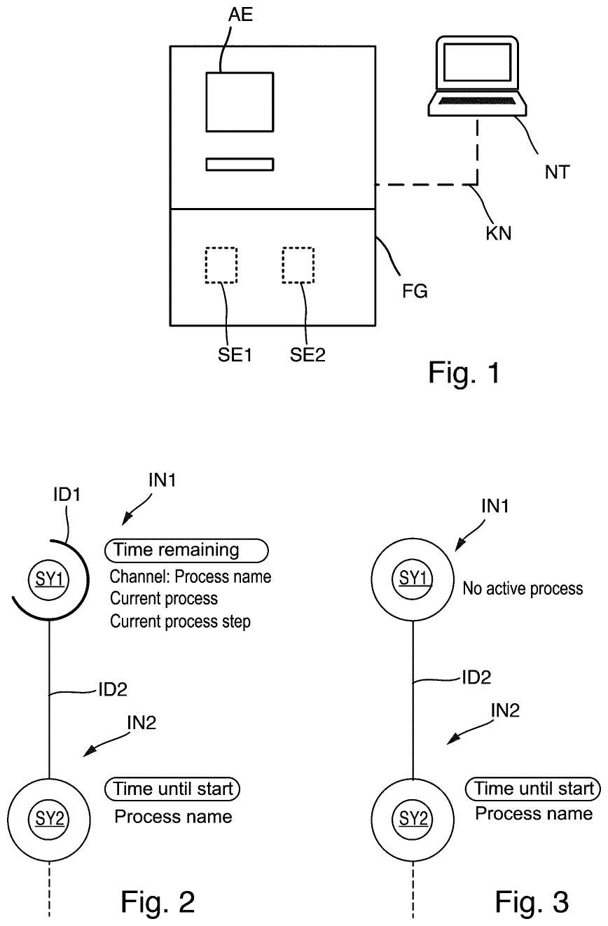

FIG. 1 shows an embodiment of the system according to the present disclosure. This system comprises a field device FG and a network participant that is connected for communication with the field device FG via a communication network KN. The field device FG in the present case is a so-called analyzer comprising a plurality of sensors SE1, SE2 in a housing, which sensors record physical or biological measured values of a sample, for example a water or food sample. The second transmitter has a display unit AE, in particular a liquid crystal display or an LED display, which can display a user interface GUI of an operating program. For example, when a measurement process is executed, the individual sensors SE1, SE2 are visualized as sensor channels on the user interface. In particular, it is provided that each sensor channel is assigned its own separate display region on the display unit AE. Displaying a sensor channel comprises, for example, displaying the name of the sensor SE1, SE2 and its current measured values.

The user interface GUI can be transmitted alternatively (for example, if the field device FG does not have a display unit AE) or additionally to the network participant NT, which then displays the user interface GUI. In this case, the network participant NT is, for example, a laptop or a mobile device, in particular a smartphone, a tablet or smart glasses, whereby the communication network KN is a wired network, for example an Ethernet network, or a wireless network, in particular based on Bluetooth, Bluetooth LE or Wi-Fi.

According to the present disclosure, it is provided that a current first process and a second process following the first process are displayed in an abstract manner on the user interface GUI.

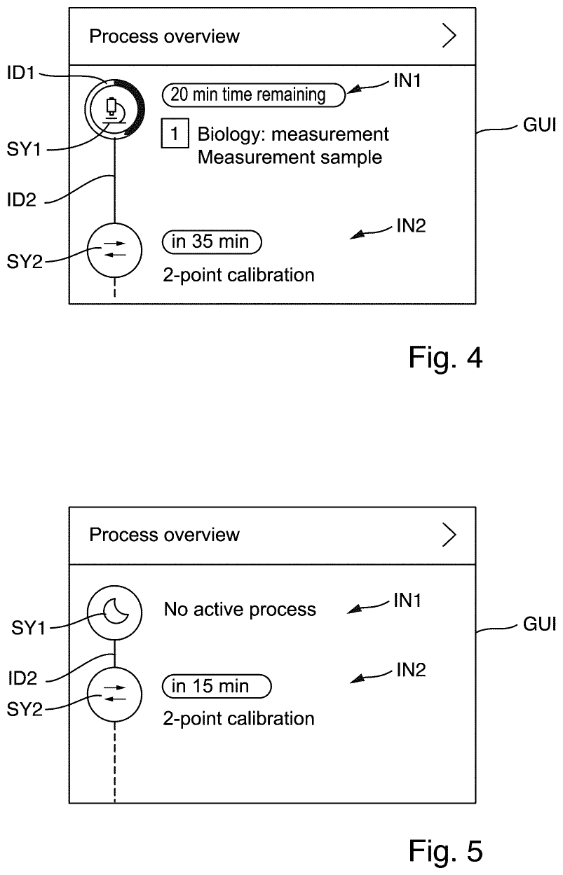

To this end, FIGS. 2 to 5 show embodiments of the user interface GUI. FIG. 2 shows a general representation of a user interface GUI in which a first process is currently being executed and wherein a second process is scheduled and intended to be subsequently executed. FIG. 4 concretizes this example and names specific first and second processes, or concrete information about the processes and their durations.

FIG. 3 shows a general representation of the user interface GUI in which no first process is currently being executed or scheduled, but in which a second process is scheduled and intended to be executed after a certain time period has elapsed. FIG. 5 concretizes this example and names a specific second process and gives concrete information about the second process, as well as the time period until the second process is executed.

The following description of the user interface is generally valid for all embodiments of the user interface GUI shown in FIG. 2 to FIG. 5. First information IN1 for the first process are displayed on the user interface GUI. The first information contain, for example, the name of the first process, a description thereof, a first symbol SY1 for the first process, information about the remaining execution time of the first process, any process steps contained in the first process, and a first indicator ID1.

The first indicator ID1 is designed as a circle or circular arc, which is arranged on the user interface in such a way that it encloses the first symbol SY1. The first indicator ID1 refers to a remaining first time period until completion of the first process. The first indicator ID1 is designed in such a way that the circular arc, or the degree to which the circumference is filled, decreases proportionally as the first time period progresses and reduces. This means that the circular arc forms a complete circumference at the start of the first process, then progressively decreases and is no longer present at the end of the first process, i.e. when the first time period has elapsed. In the embodiment shown in FIG. 4, it is also provided to display the already expired part of the circular arc in gray.

Furthermore, second information IN1 are displayed on the user interface GUI for the second process. The second information contain, for example, the name of the second process, a description thereof, a second symbol SY2 for the second process, information about the time remaining until the second process is executed, any process steps contained in the second process, and a second indicator ID2.

The second indicator ID2 is designed as a bar arranged on the user interface in such a way that it connects the first symbol SY1 to the second symbol SY2. The second indicator ID2 refers to a remaining second time period until the second process is executed. The second indicator ID2 is designed in such a way that the length of the bar decreases proportionally as the second time period decreases and brings the second symbol SY2 closer to the first symbol SY1. This means that the length of the bar—and thus the distance from the second symbol SY2 to the first symbol SY1—is at its maximum at the start and then decreases progressively. In particular, it is provided that only the position of the second symbol SY2 on the user interface GUI changes and that the position of the first symbol SY1 on the user interface always remains the same.

After the second time period has elapsed, the second symbol SY2 replaces the first symbol SY1. The method can then be repeated accordingly. It may also be provided that more than two processes are represented in this way.

The user interface GUI receives the information IN1, IN2 relating to the processes from the computing unit of the field device FG. In particular with regard to the first and second time periods, it can be provided that the field device FG simulates these time periods and/or calculates them on the basis of, in particular, its own historical values.

According to the present disclosure, the user is thus provided with information about how long the current process or the current process step has left and the length of time until the next process step starts in a simple manner. The user is therefore assured of what the device is currently doing and how and when they can or must intervene safely.

1. An automation field device which has a display unit with a user interface or which is designed to make the user interface available to a network participant via a communication connection, wherein the field device is designed to carry out a plurality of different processes or process steps within such a process, wherein the field device is designed to output first information about a current first process or first process step together with second information about at least one second process or second process step following the first process or first process step, via the user interface, wherein the first information comprise a name and/or a description of the first process or process step, and a first indicator of a remaining first time period until the completion of the first process or first process step, and wherein the second information comprise a name and/or a description of the second process or process step, and a second indicator of a remaining second time period until the second process or process step is carried out.

2. The field device according to claim 1, wherein the first time period and/or the second time period is/are calculated on the basis of one or more simulations.

3. The field device according to claim 1, wherein the first time period and/or the second time period are calculated on the basis of historical values.

4. The field device according to claim 1, wherein the first information comprises a first symbol and wherein the second information comprises a second symbol.

5. The field device according to claim 1, wherein the first indicator is designed as a circular arc, wherein the circular arc increases or decreases proportionally to the progression of the first process or first process step.

6. The field device according to claim 5, wherein the circular arc is arranged as a first indicator around the first symbol.

7. The field device according to claim 1, wherein the second indicator is designed as a bar, the length of which is proportional to the progression of the second process or second process step.

8. The field device according to claim 7, wherein, as a second indicator, the bar connects the first symbol to the second symbol.

9. The field device according to claim 1, wherein the field device is designed to switch the first process or first process step for the second process or second process step after completion such that the second process or second process step becomes the current first process or process step.

10. The field device according to claim 1, wherein the field device is an analyzer having measuring electronics, sample holders and a plurality of sensors for recording physical, chemical or biological parameters of a sample.

11. The field device according to claim 10, wherein a process is one of the following:
recording physical, chemical or biological parameters of the sample;
cleaning sample holders and/or sensors;
maintenance mode;
checking a measurement deviation;
calibrating the analyzer.

12. A system comprising a field device according to claim 1, and a network participant, wherein the field device and the network participant are connected for communication via a communication network, wherein the field device is designed to make the user interface available to the network participant via a communication connection.
